(19) United States
(12) Patent Application Publication
(10) Pub. No.: US 2005/0204394 A1
(43) Pub. Date: Sep. 15, 2005

(54) Movie distribution system

(76) Inventor: Liem Quang Nguyen, Westminster, CA (US)

Correspondence Address: Michael I. Kroll, 171 Stillwell Lane, Syosset, NY, 11791, US

(21) Appl. No.: 10/736,274

(22) Filed: Dec. 15, 2003

(51) Int. Cl. H04N 7/173; G06F 13/00; H04N 5/445; G06F 3/00; H04N 7/16

(52) U.S. Cl. 725/86; 725/87; 725/1; 725/61

(57) ABSTRACT

A system is disclosed for distributing data representing movies and/or mini-series. The system includes a database for storing and cataloging data representing pre-recorded movies. A billing system is connected to the database for selectively providing and controlling access to the data. The system further includes a user interface including means for requesting the data and means for viewing the data. A transmission network is connected between the user interface and the database for selectively transmitting the data therebetween. Upon the billing system providing access to a user, the requesting means generates a data request for retrieving the data from the database for transmission of the data via the transmission network for viewing by the viewing means.

### BACKGROUND OF THE INVENTION

1. Field of the Invention

The present invention relates a movie distribution system, and more specifically, to a system allowing a plurality of users to access a database containing a plurality of movies via a transmission network for viewing thereof. The database of the movie distribution system includes a storage unit that can be selectively updated with new content. The movie distribution system includes an interactive menu system for remotely communicating with and accessing content stored on the storage unit of the database. This system is particularly useful for distributing movies or series programs made up of a plurality of parts specifically movies and series originating in Asia.

2. Description of the Prior Art

Numerous systems designed for content distribution have been provided in prior art. For example U.S. Pat. Nos. 3,729,581, 4,890,320, 4,891,694, 3,639,686, 4,381,522, 4,506,387, 4,734,764, 5,151,782, 5,559,549, 6,243, 465, 6,275,989 and U.K. Patent Application No.: 2,356,767 A, are all illustrative of such prior art. While these systems may be suitable for the purposes for which they were designed, they would not be as suitable for the purposes of the present invention, as hereinafter described.

An instructional television system is provided for making available non-print learning materials upon request. The instructional system includes a central library store for storage of programs of learning materials. Learning materials are selectively transmitted via a TV transmitter link after being addressed with a predetermined three variable (tone, duration and period of silence) code. The code serves to “un-clock” or activate one or more decoders disposed at a plurality of subscriber station. Each decoder at a subscriber station can be programmed to any one of a plurality of two-tone sequential codes. The activated encoder serves to actuate an associated video tape recorder to record the selected transmitted material after which all remote subscriber video tape recorders previously activated by the coded transmission signal are deactivated.

A cable television system includes a minicomputer that responds to signals from viewers desiring to see particular television program material to provide a schedule video signal that is broadcast over a program schedule channel carrying a video signal representative of television programs to be broadcast, the time of broadcast and the channel where broadcast. The computer also provides selecting control signals that causes a particular television signal source, such as on a video tape cassette, disc or film, to provide a video signal that is coupled by a video switch controlled by switching control signals from the computer for modulating a television transmitter associated with a channel selected for broadcasting the selected television program material. A television signal combiner combines the signals from the different television transmitters for broadcast over a cable to the remote receiving locations. A viewer at a remote receiving location may select a particular television program for viewing by dialing a telephone number to connect the telephone at the remote receiver location by the telephone system to the minicomputer and then dial a number corresponding to the desired program on a schedule made available to each person at the remote receiving locations.

A programming-on-demand cable system is provided which allows any one of a plurality of individual users to request anyone of a plurality of video programs they wish to view from a library of programs, and permits the requested program to be available for viewing on a conventional television set at the user's location following a request initiated by the user. Each program is preprogrammed in a memory device selectable by a host computer at a central data station in response to an address signal transmitted from the user. The host computer in conjunction with other electronics transmits the video program at a high non-real-time rate over a fiber optic line network to a data receiving station at the user's location. The data receiving station then converts the received optical data back to electrical data and stores it for subsequent real-time transmission to the user's television set. The system permits the user to view any one of a number of programs transmitted on a non-real-time basis, and also allows the user to store the transmitted program at his data receiving station for an indefinite period of time for viewing at a later date. A method is also provided for transmitting the programs on a non-real-time basis.

A market-testing television system which may be utilized with present day television systems and is capable of selecting specific sections of a general audience listening to a conventional channel and providing an auxiliary program for the selected sections.

A method of, and a system for, selectively delivering still television video with accompanying audio to home subscribers over a cable television system for advertising, promotional or educational purposes. A maximum number of home subscribers can interactively request presentations of their own choosing to be displayed on their home television sets. Only one standard television channel is required for transmission of still video with accompanying audio to serve 300 concurrent users. No equipment is required in the subscriber's home. The video is presented as still frames from one of a number of videodisc players, transmitted over one television channel during the appropriate time interval of 1/30th (or 1/25th) of a second. Such video frames, which may also contain overlaid graphics information, are uniquely addressed to a remote storage device. Unused bandwidth is used for the transmission of up to 300 discrete audio messages. The remote storage device identifies the appropriate video still frame, stores it, combines it with the corresponding audio message and conveys both to the home subscribers' television on a pre-selected channel. By uniquely addressing video frames to the remote storage device, either 30 (or 25) different video frames per second can be conveyed on one television channel to 30 (or 25) different remote storage devices for retransmission to home subscribers. Thus, if a home subscriber sees a given still video frame for 10 seconds, his remote storage device need not be updated for those 10 seconds, enabling the system to transmit 300 (10 seconds. times.30/second) different video frames to 300 other remote storage devices, thereby serving 300 concurrent users.

A televsion broadcast system using land lines is provided for real-time transmission of a viewer-chosen program at a viewer requested time to the requesting viewer's television receiver. The preferred method includes the steps of providing a collection of stored programs, communicating the requesting veiwer's choice of the program chosen from the collection and a requested time for viewing the chosen program, selecting the chosen program from a collection, transmitting the chosen program at the requested time for viewing on the requesting viewer's receiver, and preventing intelligible viewing of the chosen program on other receivers.

In a system for distributing CATV signals to multiple customer locations, each location is connected to a remote terminal via a dedicated optical fiber. The tuner associated with each customer TV set is located in the remote terminal. Channel-selection signals are sent over the fiber from the customer location to the-remote terminal. Only the single selected channel is then transmitted over the fiber from the remote terminal to the associated TV set.

In a system including an originating source for providing multiple television programs to one or more local cable television systems for their distribution on a pay-per-view basis, data processing equipment at the originating source stores, for each local cable system, address information, information regarding which of the programs offered by the source it wishes to carry and the times it wishes to present each to its subscribers, and information identifying its addressable head-end equipment. The data processing equipment periodically assembles and communicates to all of the local cable systems, via a satellite channel independent from the channel used for communicating program signals, a binary message which contains address and program schedule information for each of the local cable systems. Data processing equipment at the head-end of each cable system stores command information for effecting future switching of its scrambling equipment to accomplish timely delivery to its subscribers of its offered schedule of programs. Telephone equipment at the originating source capable of receiving toll-free telephone calls and providing ANI information for the caller, allows a subscriber of any of the local cable systems to order a selected program by direct dialing the toll-free number within a prescribed time period relative to the start time of the selected program. The data processing equipment at the source is programmed to determine which local cable system serves the caller and to communicate a binary message containing information signifying that an identified one of its subscribers has ordered the selected program.

An expanded television program delivery system is described which allows viewers to select television and audio program choices from a series of menus. The primary components of the system include an operations center, a digital cable headend, and at least one set top terminal having a remote control. The system allows for a great number of television signals to be transmitted by using digital compression techniques. A combined signal is transmitted over satellite to a cable headend, which may modify the combined signal for changes or additions in programming or menu content. The combined or modified signal is subsequently distributed to individual set top terminals in the cable network. Menus are partially stored in a set top terminal in each subscribers home and may be reprogrammed by signals sent from the operations center or headend. Numerous types of menus may be used, incorporating information included within the video/data signal received by the set top terminal. A remote control unit with icon buttons allows a subscriber to select programs based upon a series of major menus, submenus, and during program menus. Various data gathering and analysis techniques are used to compile programs watched information that in turn is used in packaging programs, customizing menu selections, targeting advertisements, and maintaining account and billing information. A method for providing video programming in a nearly on demand basis is disclosed. A video network includes a video server that operates several video recorders to simultaneously exhibit video performances or programs on a plurality of channels. The video server is controlled in real time in accordance with data presented to it in an exhibition plan. The exhibition plan calls for two or more channels to show the same program on a time offset basis. Due to the offset in exhibiting a given program, a subscriber may view a program at any time, from the beginning of a program, by waiting for a period of time that is no longer than the offset. Preferably, this offset is substantially shorter than the run time of the program. The channels carrying this program are unscrambled prior to the beginning of the program and for a predetermined duration into the program so that subscribers may preview the program. However, the channels are scrambled for the remainder of the exhibition of the program. A subscriber may order the program when it begins and for a short duration after the program becomes scrambled.

A system and method for displaying still video images related to video content in an interactive broadcast television system. The system and method of the present invention may also be used for simulating an Internet home page on an interactive television system. The present invention thus supports hyperlinked web-like navigational capabilities in an interactive television system. According to the method of the present invention, the video delivery system provides or broadcasts one or more audio/video channels each comprising video content and also provides or broadcasts at least one still image channel comprising a plurality of still video images, preferably MPEG-2 compressed still images. The user or viewer can select options displayed on the television screen to view desired information. When the set top box receives user input selecting an option to view one of the linked still images, the set top box captures the requested image from the still image broadcast channel, stores the image in memory, and displays the captured still video image corresponding to the selection. The still image being displayed may have associated interactive program content for displaying further selections, wherein these selections may be for viewing other images or content, for ordering information, or purchasing products. The user can thus selectively navigate between the video content and stills in a web-like hyperlinked fashion. In one embodiment, when a user is navigating through still images, the television program or video content which was being viewed is displayed in a small window overlaid on the still image being displayed. Also, when the set top box captures a requested image from the still image broadcast channel, the set top box preferably also pre-caches or pre-loads other related still images based on the probabilty that these related images will be subsequently requested by the user. The invention also includes an embodiment which provides user requested still images “on demand” on a dedicated “search” channel.

The present invention relates to an interactive digital system (1) enabling viewers full and active participation in experiencing a live broadcast event. Particularly, the presentation of the live event is personalized for the viewer through the provision of options, including multiple video streams, associated with different camera angles, for example, and integrated audio and graphic segments. Further, information obtained from related Web sites can be integrated into the live program. A profile is created for the user.

### SUMMARY OF THE PRESENT INVENTION

The present invention relates a movie distribution system, and more specifically, to a system allowing a plurality of users to access a database containing a plurality of movies via a transmission network for viewing thereof. The database of the movie distribution system includes a storage unit that can be selectively updated with new content. The movie distribution system includes an interactive menu system for remotely communicating with and accessing content stored on the storage unit of the database. This system is particularly useful for distributing movies or series programs made up of a plurality of parts specifically movies and series originating in Asia.

A primary object of the present invention is to provide a movie distribution system that overcomes the shortcomings of the prior art.

Another, secondary object of the present invention is to provide a movie distribution system including a database and a user-interface connected via a transmission network.

Yet another object of the present invention is to provide a movie distribution system wherein the database includes a storage unit for storing a plurality of content.

Another object of the present invention is to provide a movie distribution system wherein the content includes at least one of feature length movies, mini-series and individual television shows.

An even further object of the present invention is to provide a movie distribution system wherein the database includes at least one input device for selectively updating the content stored on the storage unit.

A further object of the present invention is to provide a movie distribution system wherein the input device is at least one of a DVD-drive, a VHS tape player, an 8 MM tape player, MPEG player and the Internet.

Still yet another object of the present invention is to provide a movie distribution system wherein the user-interface is interactive and allows the user to scan through all the content stored on the storage unit.

A further object of the present invention is to provide a movie distribution system including a payment system for receiving payments from a user and thus granting access to the movie distribution system.

An even further object of the present invention is to provide a movie distribution system wherein the payment system includes at least one of a monthly service fee and pay-per-use.

Still an even further object of the present invention is to provide a movie distribution system including a user access code provided to the user for accessing the content stored on the storage unit.

Yet another object of the present invention is to provide a movie distribution system wherein the user must input the access code to view the content on a display screen at the user's location.

A further object of the present invention is to provide a movie distribution system wherein the transmission network is a high speed network for simultaneously connecting a plurality of user's to the database.

An even further object of the present invention is to provide a movie distribution system wherein each user connected via the transmission network can selectively access all the content.

Yet another object of the present invention is to provide a movie distribution system wherein the transmission network is at least one of a satellite network and the Internet.

Another object of the present invention it to provide a movie distribution system for providing users with movies filmed and available in Asia.

Yet another object of the present invention is to provide a movie distribution system that efficiently allows a user to watch a movie or series having a plurality of parts and which span substantially 20 hours.

An even further object of the present invention is to provide a movie distribution system that reduces the amount of time required to obtain a movie having a plurality of parts.

Still another object of the present invention is to provide a movie distribution system that utilized communication lines of the local cable company for distributing the movies.

Additional objects of the present invention will appear as the description proceeds.

The present invention overcomes the shortcomings of the prior art by providing a a movie distribution system allowing a plurality of users to access a database containing a plurality of movies via a transmission network for viewing thereof. The database of the movie distribution system includes a storage unit that can be selectively updated with new content. The movie distribution system includes an interactive menu system for remotely communicating with and accessing content stored on the storage unit of the database. The present invention is directed specifically at distributing movies that originate in Asia and include a number of individual installments.

The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawing, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 is an illustrative view of the movie distribution system of present invention connecting a user to a database via a transmission network;

FIG. 2 is a block diagram of the movie distribution system of the present invention floor showing a plurality of users connected thereto;

FIG. 3 is a block diagram of the movie distribution system of the present invention showing the connection of the database to a user interface via the transmission network;

FIG. 4 is a block diagram of the user inputs of the movie distribution system of the present invention;

FIG. 5 is a block diagram of the system inputs of the movie distribution system of the present invention; FIG. 6 is a front view of the user interface of the movie distribution system of the present invention in navigation mode;

FIG. 7 is a flow chart showing the operation of the movie distribution system of the present invention;

FIG. 8 is a flow chart showing the payment method of the movie distribution system of the present invention; and

FIG. 9 is an illustrative view of the movie distribution system of the present invention.

### DESCRIPTION OF THE REFERENCED NUMERALS

Turning now descriptively to the drawings, in which similar reference characters denote similar elements throughout the several views, the Figures illustrate the movie distribution of the present invention. With regard to the reference numerals used, the following numbering is used throughout the various drawing Figures.
10 movie distribution system of the present invention
11 first communication device
12 database
13 third communication device
14 first processor
15 power source
16 first transmitter
17 storage unit
18 first receiver
19 system input
20 transmission network
21 second communication device
22 second processor
24 second receiver
26 second transmitter
28 second transmission device
30 user interface
32 third processor
33 third transmission device
34 third transmitter
36 third receiver
38 user inputs
39 display
42 remote
44 keyboard
46 mouse
48 DVD-ROM
50 VHS tape player
52 8 mm tape player
54 MPEG reader
56 Internet connection
58 navigation interface
60 user input field
62 first content field
63 second content field
64 third content field
66 first action button
67 second action button
68 third action button
70 directional pad
72 up directional button
74 right directional button
76 right directional button
78 down directional button
80 action button
82 billing system
84 main cable
86 main box
88 television
90 in-home receiver
92 transmission network

### DETAILED DESCRIPTION OF THE PREFERRED EMBODIMENT

The following discussion describes in detail one embodiment of the invention and several variations of that embodiment. This discussion should not be construed, however, as limiting the invention to those particular embodiments. Practitioners skilled in the art will recognize numerous other embodiments as well. For definition of the complete scope of the invention, the reader is directed to appended claims.

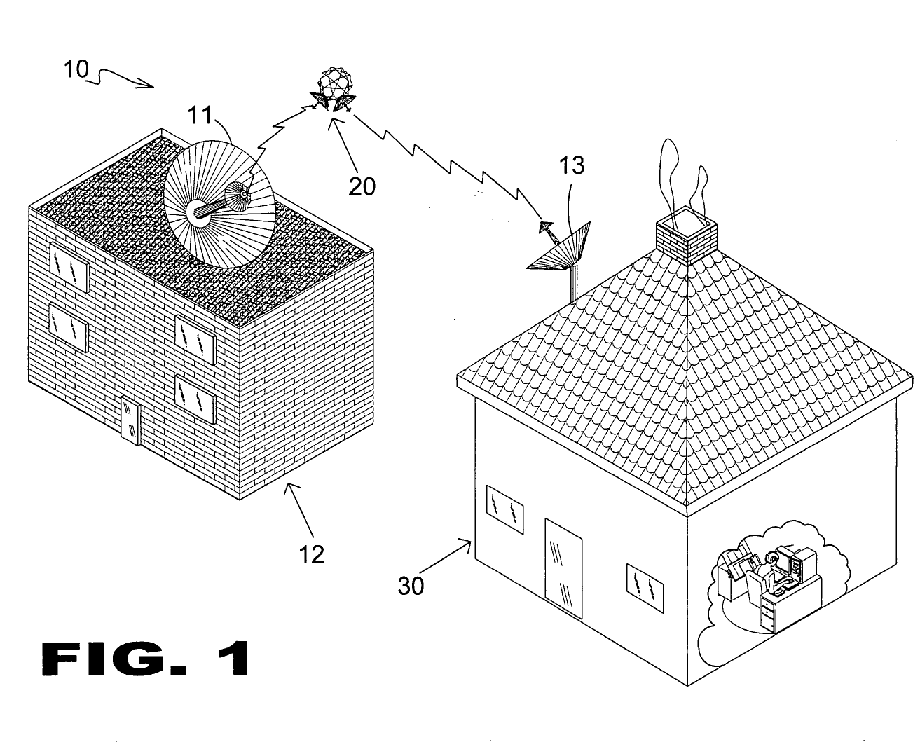

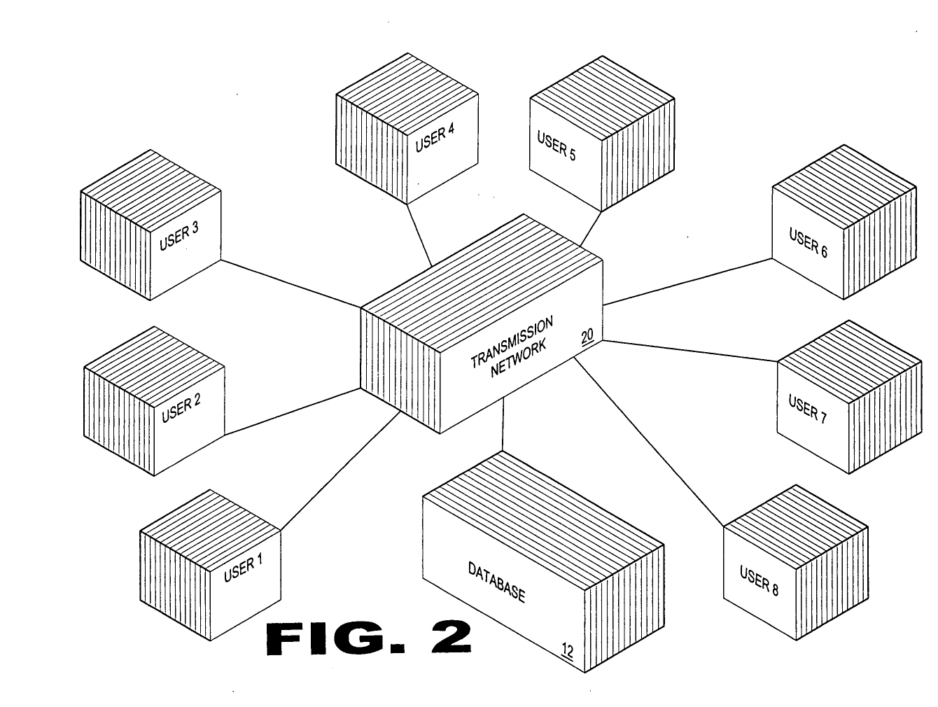

Turning now descriptively to the drawings, in which similar reference characters denote similar elements throughout the several views, FIGS. 1 through 8 illustrate a video cafe of the present invention indicated generally by the numeral 10.

FIG. 1 is an illustrative view of the movie distribution system 10 of present invention. The movie distribution system 10, hereinafter “the system”, includes at least one centrally located database 12 having data representing movies stored therein. The database 12 is connected to a first communication device 11. A user interface positioned at an end user location 30 is shown having a third communication device 13 connected thereto. As shown in FIG. 1, both the first, second and third communication devices 11, 13, 21 are satellite dishes. However, the communication devices 11,13, 21 may be any device that enables both the database 12 and the end user 30 to transmit and receive data therebetween. The system 10 further includes a transmission network 20 having a second communication device 21. The transmission network as shown in FIG. 1 is a satellite which orbits the earth. However, this transmission network 20 may be any network that allows transmission of data between at least two locations.

Upon the end user 30 desiring to view a movie, the end user 30 transmits a data request via the second communication device 13. The data request is received by and transmitted over the transmission network 20. Thereafter, the data request is received by the first communication device 11. The database 12 is accessed and movie data that matches the data request from the end user is retrieved from the database 12. The retrieved movie data is then transmitted via the first communication device 11 for receipt by the transmission network 20. The movie data is then transmitted over the transmission network 20 and received by the first communication device 11. Upon receiving the movie data, the user is able to view the movie data on a display screen. The method by which movies are distributed by the system 10 of the present invention will be discussed hereinafter with specific reference to FIGS. 2-9.

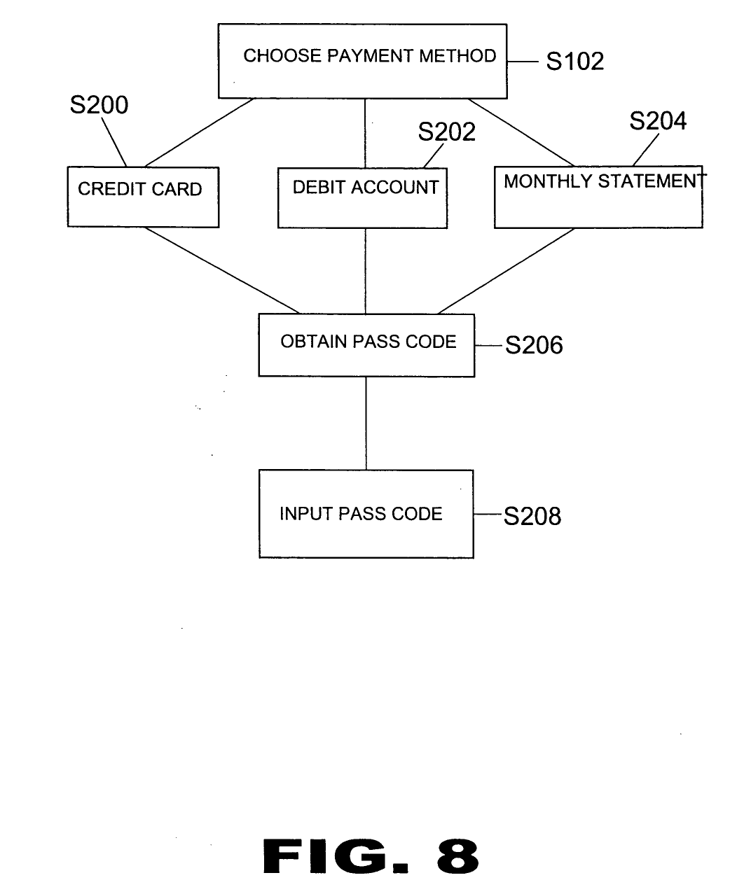

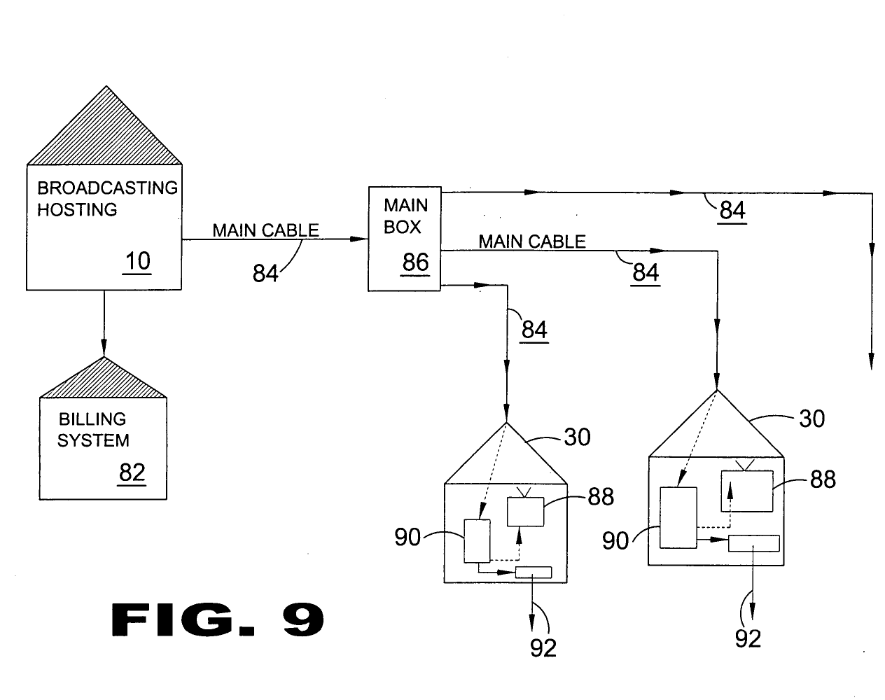

Additionally, as shown in FIGS. 8 and 9, the system 10 includes a dedicated billing system 82 for allowing selective access to movies stored in the database 12. The billing system 82 gives a user different method of payment option in order to access the data stored in the database 12.

The movie distribution system 10 is preferably used to distribute movies that produced in Asia as these movies are significantly longer than movies which are produced and distributed in US theaters and video stores. These movies generally include a number of individual parts which, if viewed individually, would require a user to procure a large number of video tapes or DVD's containing these parts. The system 10 of the present invention allows an end user to easily obtain the desired movie and/or installments of each movie without having to physically obtain media containing the movies.

FIG. 2 is a block diagram of the movie distribution system of the present invention floor showing a plurality of users connected thereto. The movie distribution system 10 of the present invention preferably includes a plurality of users that are selectively connected to the central database 12 via the transmission network 20. As shown herein, there are Users 1-8 connected to the database 12 by the transmission network 20. Each respective one of Users 1-8 includes a communication device which can selectively transmit data requests and receive data representing movies as discussed hereinabove with specific reference to FIG. 1. The system 10 allows all Users 1-8 to simultaneously access the data stored and catalogued by the database 12. Each user can selective choose a movie to retrieve from the database 12. The users could all choose at least one of the same movie and different movies for viewed at the end user location. Additionally, the system 10 having 8 users connected thereto is described for purposes of example only and the system may include any number of users for accessing data stored in the database 12 via the transmission network 20.

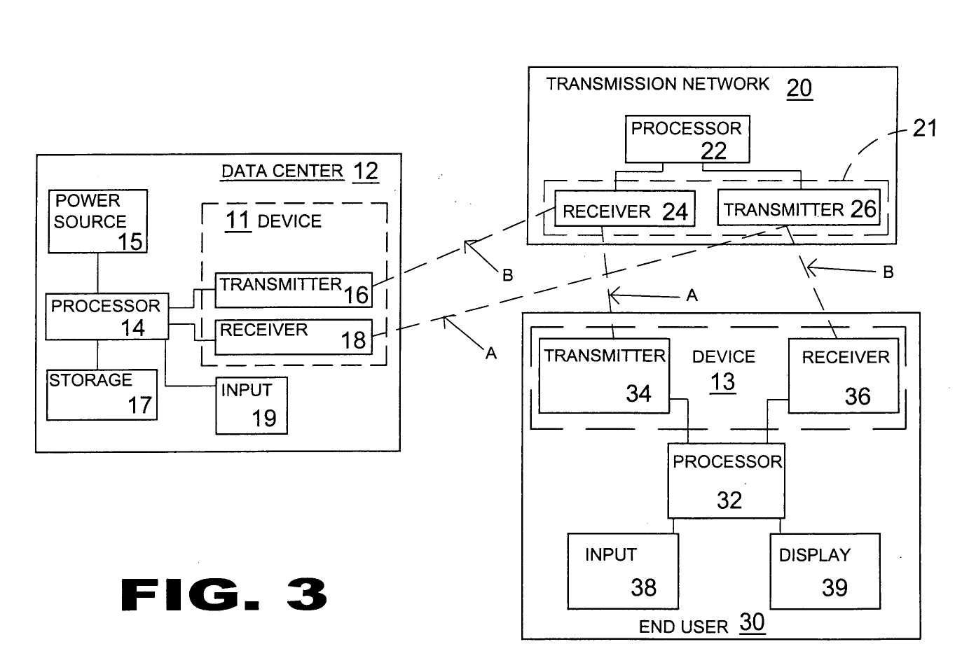

FIG. 3 is a block diagram of the movie distribution system of the present invention showing the connection of the database 12 to a end user interface 30 via the transmission network 20. The database 12 includes a processor 14 and a power source 15 connected thereto for providing power to the database 12. A storage device is also connected to the processor 14 for storing data representing movies thereon. An input 19 is connected to the processor 14 for providing new data to be stored on the storage device 17. The first communication device 11 is further connected to the processor 14. The first communication processor includes a first transmitter 16 and a first receiver 18. The transmission network 20 of the system 10 includes the second communication device 21. The second communication device includes a second processor 22 and a second receiver 24 and a second transmitter 26. The end user interface 30 includes a third processor 32 and an input device 38 and display 39 each connected to the third processor 32. The third communication device 13 is also connected to the third processor 32. The third communication device 13 includes the third transmitter 34 and the third receiver 36.

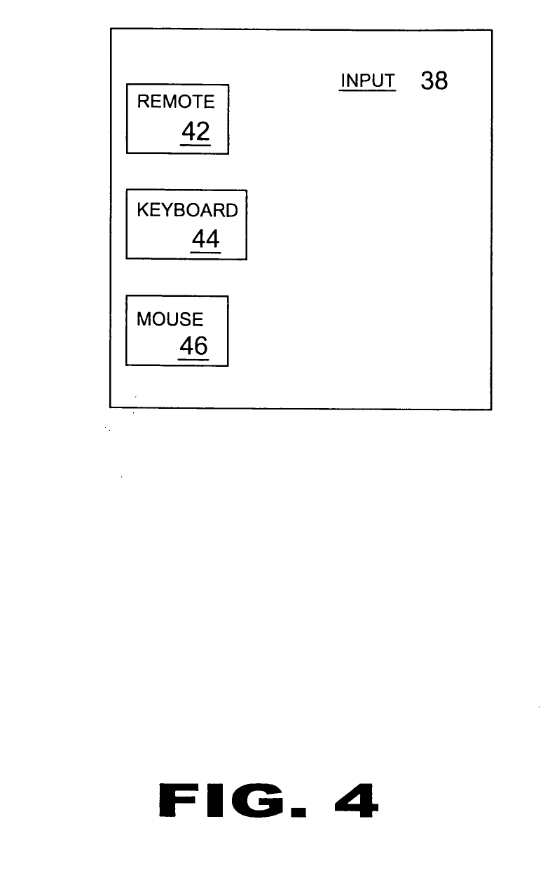

The end user 30 inputs a data request using the input device 38. Preferably, the input device is a remote control which will be discussed hereinafter with specific reference to FIGS. 4 and 6. The third processor 32 directs the third transmitter 34 to transmit the data request, labeled with reference character “A”, over the transmission network 20. Data request “A” is received by the second receiver 24 and, upon receipt, the second processor 22 directs the second transmitter 26 to transmit “A” to the database 12. Data request “A” is received by the first receiver 18 of the database 12. The first processor 14 retrieves data stored on the storage device 17 that matches the data request “A”. The first processor 14 then directs the first transmitter 16 to transmit the retrieved data represented by reference character “B” over the transmission network 20. The second receiver 24 receives retrieved data “B” and the second processor 22 directs the second transmitter 26 to transmit retrieved data “B” to the end user 30. The retrieved data “B” is received by the third receiver 36. Thereafter, the third processor 32 causes retrieved data “B” to be displayed on the display 39.

FIG. 4 is a block diagram of the user inputs of the movie distribution system of the present invention. As shown in FIG. 4, the database 12 includes a processor 14 and a power source 15 connected thereto for providing power to the database 12. A storage device is also connected to the processor 14 for storing data representing movies thereon. A system input 19 is connected to the processor 14 for providing new data to be stored on the storage device 17. The first communication device 11 is further connected to the processor 14. The first communication processor includes a first transmitter 16 and a first receiver 18. The transmission network 20 of the system 10 includes the second communication device 21. The second communication device includes a second processor 22 and a second receiver 24 and a second transmitter 26. The end user interface 30 includes a third processor 32 and an input device 38 and display 39 each connected to the third processor 32. The third communication device 13 is also connected to the third processor 32. The third communication device 13 includes the third transmitter 34 and the third receiver 36. The input device 38 includes at least one of a remote control unit 42, a keyboard 44 and a mouse 46. The user can selectively choose the content to be viewed at the end user location using the input device 38. Preferably the input device 38 is a remote control unit 42. The remote control unit 42 is described in greater detail hereinafter with specific reference to FIG. 6. However, if the input device is at least one of the keyboard 44 or mouse 46, the user can selectively choose the desired content via a personal computer that is selectively connected to the transmission network 20.

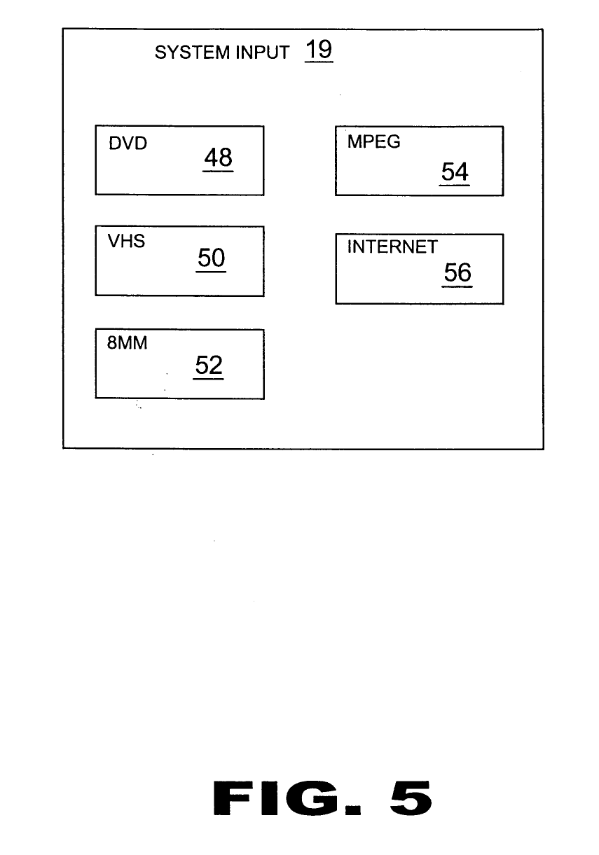

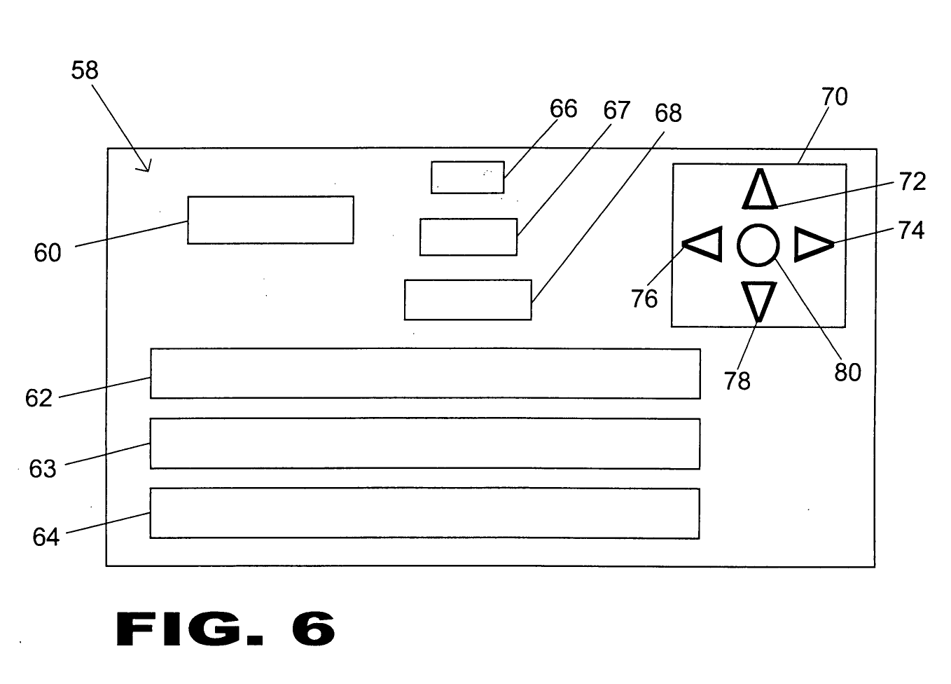

FIG. 5 is a block diagram of the system inputs of the movie distribution system of the present invention. As shown in FIG. 4, the database 12 includes a processor 14 and a power source 15 connected thereto for providing power to the database 12. A storage device is also connected to the processor 14 for storing data representing movies thereon. A system input 19 is connected to the processor 14 for providing new data to be stored on the storage device 17. The first communication device 11 is further connected to the processor 14. The first communication processor includes a first transmitter 16 and a first receiver 18. The transmission network 20 of the system 10 includes the second communication device 21. The second communication device includes a second processor 22 and a second receiver 24 and a second transmitter 26. The end user interface 30 includes a third processor 32 and an input device 38 and display 39 each connected to the third processor 32. The third communication device 13 is also connected to the third processor 32. The third communication device 13 includes the third transmitter 34 and the third receiver 36.

The system input 19 connected to the first processor 14 allows a system manager to selectively update and add content to the movie selection stored in storage device 17. The system input includes at least one of a DVD player, a VHS player, an 8 MM tape player, an MPEG player, and the internet. The system manager may add content contained on a DVD to the system by inserting the DVD into DVD player 48 whereby the data stored on the DVD disc is captured and stored on the storage device 17. The system manager may selectively add content stored on a VHS tape by inserting the VHS tape into VHS player 50 whereby the data stored on the VHS tape is captured and stored on the storage device 17. The system manager may selectively add content stored on a 8 MM tape by inserting the 8MM tape into the 8MM tape player 52 whereby the data stored on the 8MM tape is captured and stored on the storage device 17. The system manager may selectively add content stored on a VHS tape by inserting the VHS tape into VHS player 50 whereby the data stored on the VHS tape is captured and stored on the storage device 17. The system manager may selectively add content stored in an MPEG file by playing the MPEG file on the MPEG player 54 whereby the data stored in the MPEG file is captured and stored on the storage device 17. The system manager may also selectively log onto the internet and download content directly to the storage device 17.

Upon adding content as discussed above to the system 10, the database selectively catalogues all content in an easily readable and understandable manner so that end users 30 may access the stored data.

FIG. 6 is a front view of the user interface of the movie distribution system of the present invention in navigation mode. The system includes a navigation device 58. Preferably the navigation device is positioned on the remote control unit 42. Alternatively, the navigation device 58 can be an on-screen navigation device. The navigation device 58 includes a user input field for inputting a data request therein. The navigation device 58 further includes a first content field 62, a second content field 63 and a third content field 64. The content fields selectively display what data is stored on the storage device 17 of the system 10. The content fields may selectively display information representing at least one of movie title, series title, and movie genre. These are described for purposes of example only and the content fields 62-64 can selectively display any information stored on the storage device 17 of the system 10. The content fields are selectively scrollable using a directional pad 70. The directional pad 70 includes an upward directional arrow 72, a right directional arrow 74, a downward directional arrow 78 and a left directional arrow 76. Positioned centrally between the directional arrows 72, 74, 76, 78 is an action button 80 for selecting a field for further navigation. The navigation device further includes a first action button 66, a second action button 67 and a third action button 68. The action buttons 66-68 may selectively be associated with each of the content fields 62-64 in order to allow a user to select data being displayed therein. Alternatively, the action buttons 66-68 may initiate different operations. The action buttons 66-68 may initiate operation of at least one of the billing system, the transmission network, and the display. These operations are described for purpose of example only and the action buttons 66-68 may initiate any function associated with the movie distribution system of the present invention.

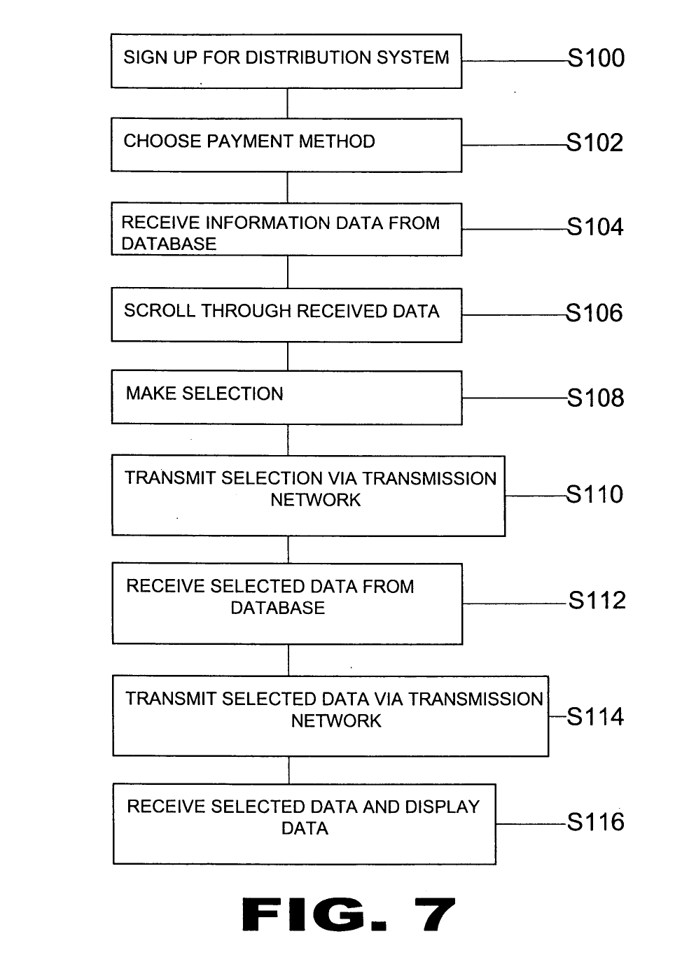

FIG. 7 is a flow chart showing the operation of the movie distribution system of the present invention. If an end user wants to access the movie distribution system 10 of the present invention, the user must first sign up for the distribution system as in step S100. Thereafter, the user must select the method of payment as required by step S102 in order for the user to gain access to the movie distribution system of the present invention. The method of payment will be discussed hereinafter with specific reference to FIG. 8. A user then receives data representing movie content that is stored and catalogued by the database as stated in step S104. The user, as stated in step S106, uses the navigation device as described hereinabove with specific reference to FIG. 6 to scroll through the data received in step S104. The user then makes a selection as stated in step S108. The data selected is transmitted as a data request via the transmission network as stated in step S110. Upon the database receiving the data request transmitted in step S110, the data that matches the data of the data request is retrieved from the database as in step S112. The retrieved data is then transmitted by the transmission network as stated in step S114 and ultimately received by the end user as stated in step S116.

FIG. 8 is a flow chart showing the payment method of the movie distribution system of the present invention. The step of choosing payment method as stated in step S102 described hereinabove with specific reference to FIG. 7 includes choosing to pay using a credit card as in step S200, a debit account as in step S202, and to have a monthly billing statement as in step S204. The end user may select any of these methods of payment to gain access to the system. Upon selecting the payment methods in steps S200-S204, the user then obtains a pass code as in step S206. In order to gain access to the data stored and catalogued by the database, the user must input the given pass code as required in step S208. Upon completing steps S200-S208, the user is then directed to proceed with step S104 as described hereinabove with specific reference to FIG. 7.

FIG. 9 is an illustrative view of the movie distribution system of the present invention. The movie distribution system 10 of the present invention is shown in FIG. 9 as using an existing network of cables to provide access to the content stored in the database 12 of the present invention. The billing system 82 is connected to the database 12 of the system and controls which users have access to the content of the system. The database 12 is shown connected via a main cable line to a main cable box 86. The main cable box 86 receives the signal from the database and replicates the signal for further transmission to a plurality of end users 30. A plurality of main cables 84 extend from the main cable box 86 and extend between the main cable box 86 and end user locations 30. Each of the end user locations 30 include an in-home receiver 90, a transmission network 92 and a display device 88. The signal received from the main cable box 86 is displayed by the in-home receiver on the display device. Preferably, the display device is a television, however, any device for displaying cable signals may be used. The transmission network 92 allows the user to send a data request through the main cable 84 for receipt by the database 12. The user makes a data request to select the desired content using the in-home receiver 90 and the data request is transmitted to the database 12 to access the desired content stored therein. This embodiment allows the movie distribution system to utilize existing cable systems to provide exclusive access to Asia movies and mini-series programs.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A system for distributing data comprising:
a) a database for storing and cataloging data representing pre-recorded movies;
b) a billing system connected to said database for selectively providing and controlling access to said data;
c) a user interface including means for requesting said data and means for viewing said data; and
d) a transmission network connected between said user interface and said database for selectively transmitting said data therebetween, wherein upon said billing system providing access to a user, said requesting means generates a data request for retrieving said data from said database for transmission of said data via said transmission network for viewing by said viewing means.

2. The system as recited in claim 1, wherein said database comprises:
a) a first processor; and
b) a first communication device connected to said first processor, said first communication device includes a first transmitter and first receiver, wherein said first processor causes said communication device to selectively receive and transmit said data over said transmission network.

3. The system as recited in claim 2, where said transmission network comprises:
a) a second processor; and
b) a second communication device connected to said second processor, said second communication device includes a second transmitter and second receiver wherein said second processor causes said second communication device to selectively receive said data from and transmit said data to each of said database and said user interface.

4. The system as recited in claim 3, wherein said user interface comprises:
a) a third processor; and
b) a third communication device connected to said third processor, said third communication device includes a third transmitter and third receiver, wherein said third processor causes said request from said requesting means to be selectively transmitted by said third processor for receipt by said second receiver and said third receiver receives said data from said second transmitter for display by said display means.

5. The system as recited in claim 4, wherein said database further comprises means for inputting data for storage in said database.

6. The system as recited in claim 5, wherein said inputting means includes at least one of a DVD player, a MPEG player, a video cassette recorder, an internet connection, and an 8 MM tape player.

7. The system as recited in claim 5, wherein said viewing means is a television screen.

8. The system as recited in claim 1, wherein said transmission network is at least one of a cable television system, a satellite transmission system, a telephone network, and a fiber optic cable network.

9. The system as recited in claim 5, wherein said request generated by said requesting means is compared by said first processor to said catalogue of said data stored in said database, and upon said first processor finding said data equal to said request, said first processor causes said first transmitter to transmit said data via said transmission network for receipt by said user interface.

10. The system as recited in claim 1, wherein said viewing means is at least one of a computer monitor and a television.

11. The system as recited in claim 1, wherein said user interface further comprises a remote control unit for selectively causing said requesting means to generate said request.

12. The system as recited in claim 1, wherein said billing system allows a user to gain access to said data using means for making a payment.

13. The system as recited in claim 12, wherein said payment making means includes at least one of a credit card payment, subscription fee payment, a debit payment, and a monthly statement requiring payment by a predetermined date.

14. The system as recited in claim 1, wherein said data represents movies filmed and produced in Asia.

15. The system as recited in claim 14, wherein said data represents movies filmed and produced by Asian production companies.

16. The system as recited in claim 15, wherein said data further includes at least one of full length motion pictures and mini-series programs having a predetermined number of parts associated therewith.
